(19) United States
(12) Patent Application Publication
(10) Pub. No.: US 2020/0085026 A1
(43) Pub. Date: Mar. 19, 2020

(54) FISHING REEL APPARATUS

(71) Applicant: Oguz Bulent Aksoy, Smith's Cove (CA)

(72) Inventor: Oguz Bulent Aksoy, Smith's Cove (CA)

(21) Appl. No.: 16/134,330

(22) Filed: Sep. 18, 2018

(51) Int. Cl. A01K 89/08; A01K 89/017; A01K 83/00

(52) U.S. Cl. CPC A01K 89/08; A01K 83/00; A01K 89/017

(57) ABSTRACT

A fishing reel apparatus including a frame, an upper spool on the frame for winding up and paying out a line, a bead on the line, a series of hooks at intervals on the line down-line of the bead, a lower spool on the frame for winding up and paying out a sheet, an opening in the sheet for receiving the line where the opening is sized to allow the line to pass through without allowing the bead to pass through, a guide roller on the frame between the upper and lower spools for guiding the sheet when the sheet is payed out to, and a drive motor operably connected to the upper spool for rotating the upper spool.

### CROSS-REFERENCE TO RELATED APPLICATION

This present application claims priority form Canadian Application Number (Not Yet Assigned) entitled FISHING REEL APPARATUS filed on Sep. 14, 2018.

### FIELD

The present disclosure relates to a fishing reel apparatus.

### BACKGROUND

It is common in fishing for certain types of fish, such as mackerel, to employ a line with multiple hooks attached at intervals along the line. Upon reeling in the line, the hooks can become tangled.

### SUMMARY OF THE DISCLOSURE

In one aspect, the present disclosure relates to a fishing reel apparatus including a frame, an upper spool on the frame for winding up and paying out a line, a bead on the line, a series of hooks at intervals on the line down-line of the bead, a lower spool on the frame for winding up and paying out a sheet, an opening in the sheet for receiving the line where the opening is sized to allow the line to pass through without allowing the bead to pass through, a guide roller on the frame between the upper and lower spools for guiding the sheet when the sheet is payed out to, and a drive motor operably connected to the upper spool for rotating the upper spool.

### BRIEF DESCRIPTIONS OF DRAWINGS

For the purpose of illustrating the invention, the drawings show aspects of one or more embodiments of the invention. However, it should be understood that the present invention is not limited to the precise arrangements and instrumentalities shown in the drawings, wherein

FIG. 1 is a side perspective view of a fishing reel apparatus according to an aspect of the present disclosure;

FIG. 2a is a perspective view of a guide roller and a guide bar with a sheet according to an aspect of the present disclosure;

FIG. 2b is a side view of guide rollers with a sheet according to an aspect of the present disclosure;

FIG. 3 is a perspective view of an upper spool, lower spool and a guide roller with a sheet according to an aspect of the present disclosure;

FIG. 4 is a perspective view of a lower spool, a sheet and line according to an embodiment of the present disclosure;

FIG. 5 is a side view of a lower spool and an auto stop according to an embodiment of the present disclosure;

FIG. 6 is a side view of a fishing reel apparatus according to an aspect of the present disclosure;

FIG. 7 is side view of a depth gauge according to an aspect of the present disclosure, and

FIG. 8 is a side view of an upper spool with a fishing line with hooks and a sheet partially wound around the upper spool. The separation between the layers is exaggerated to better illustrate the embodiment.

### DETAILED DESCRIPTION

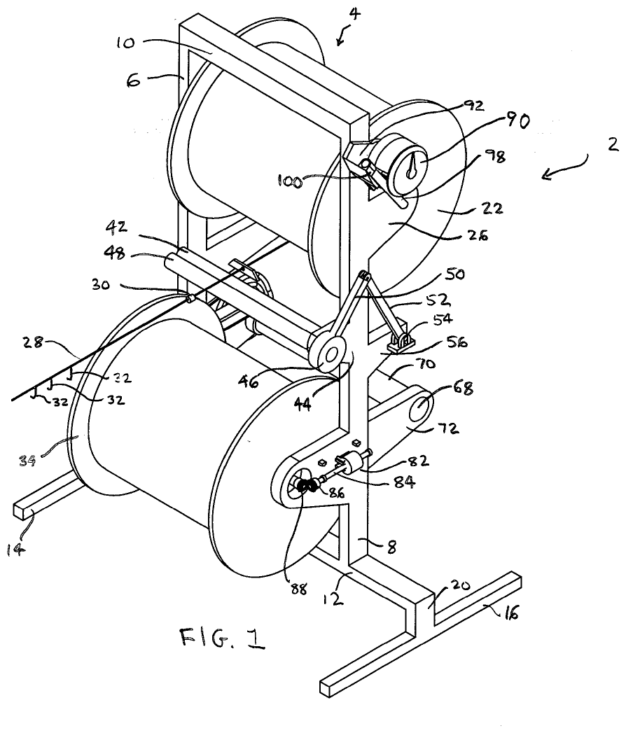

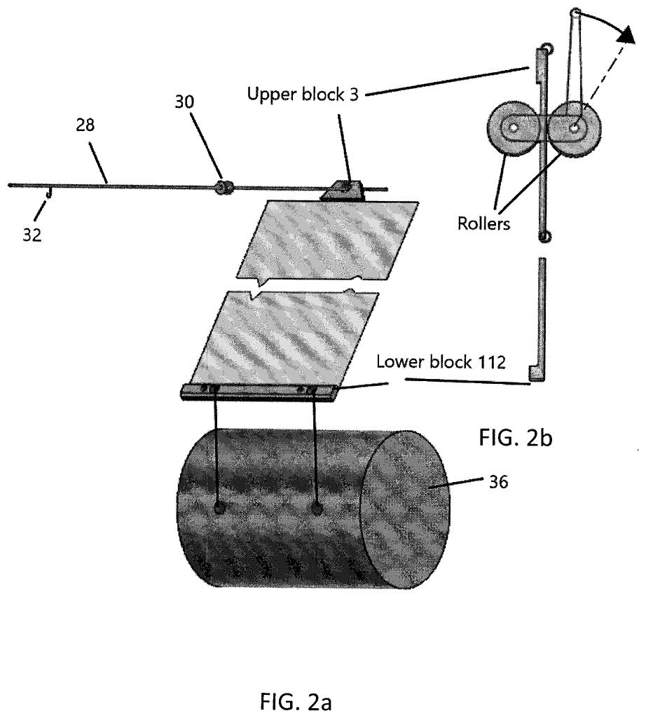

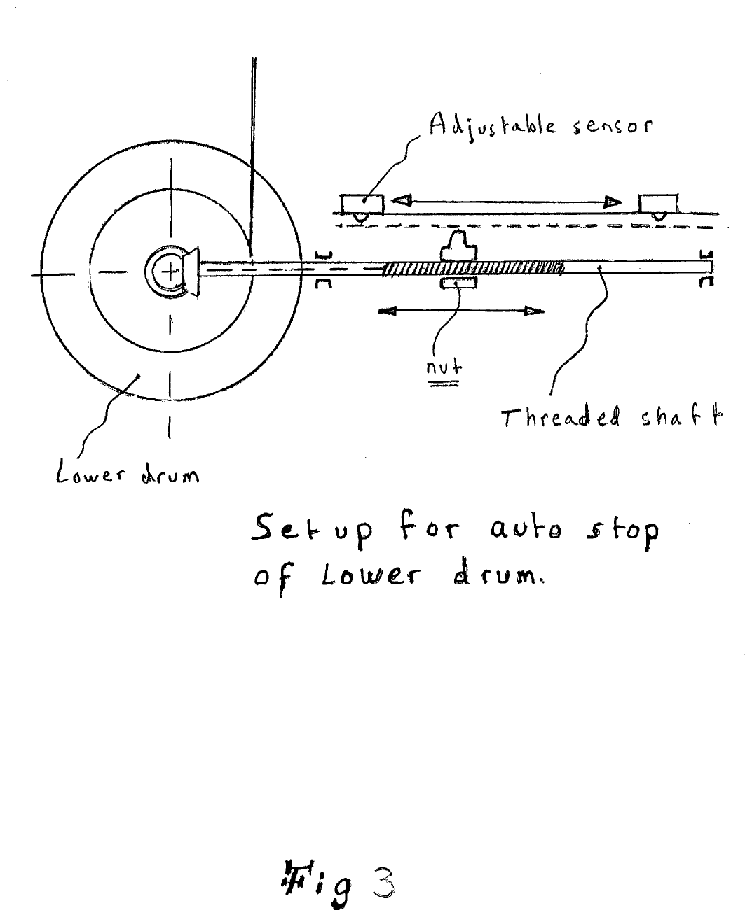

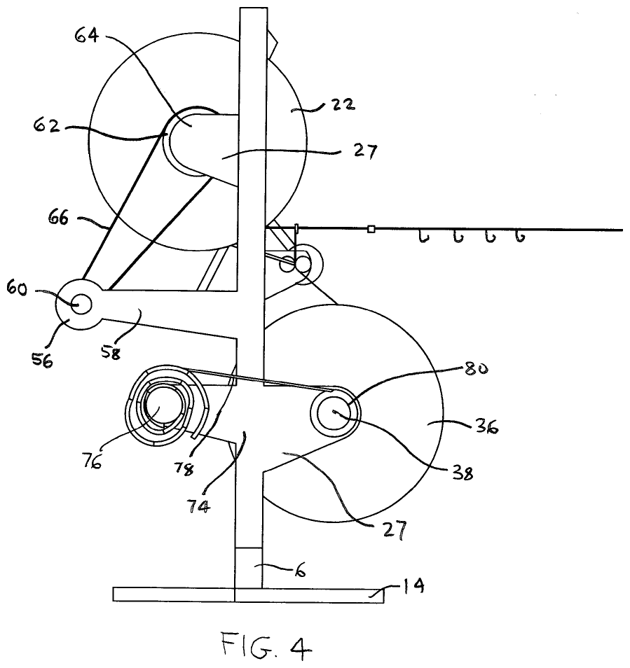

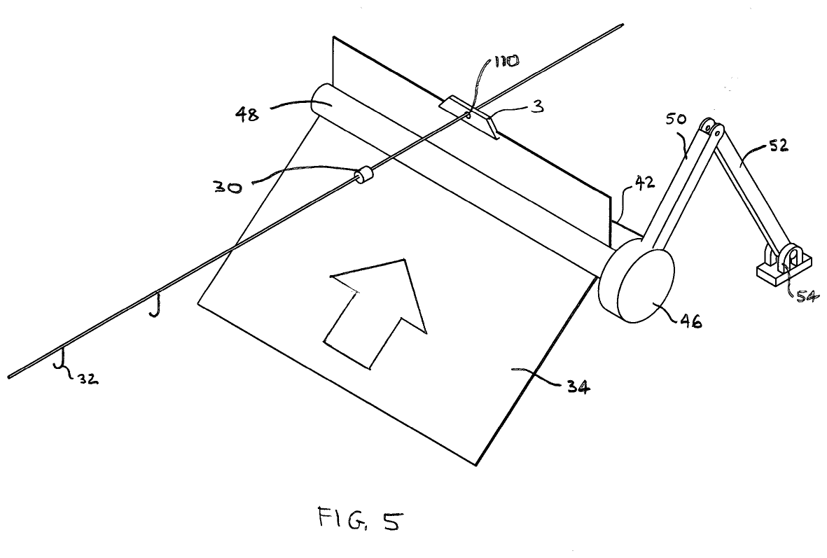

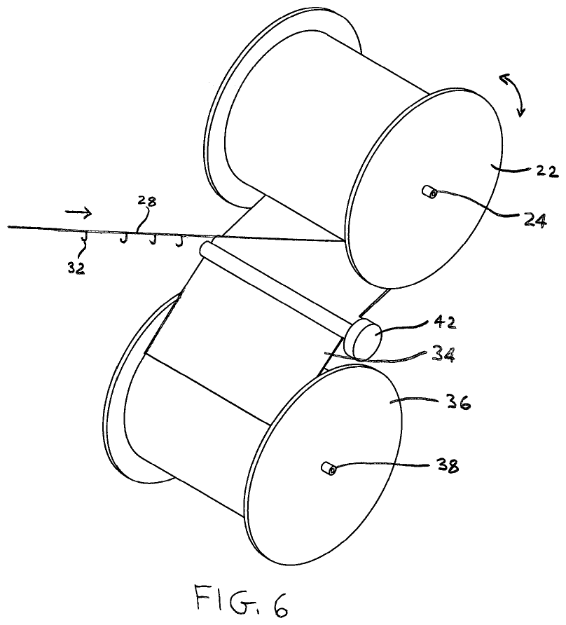

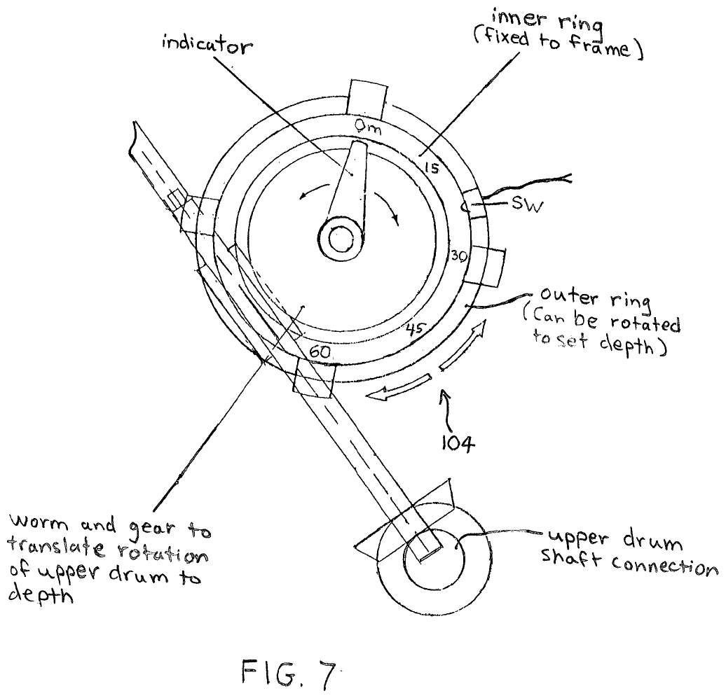

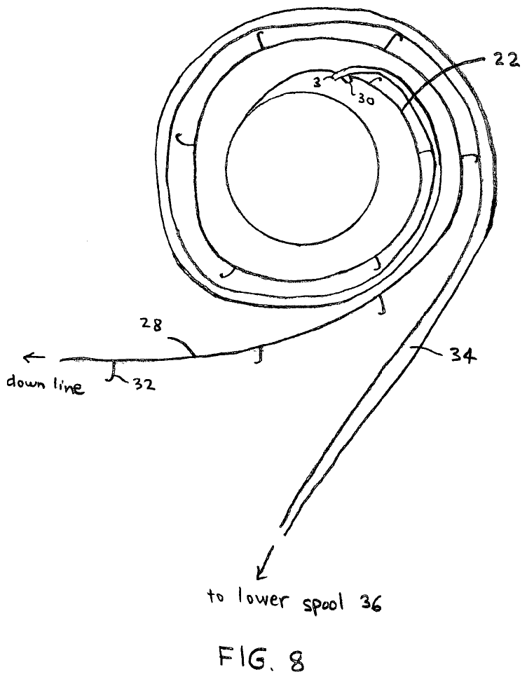

Referring initially to FIG. 1, in one embodiment, the present invention relates to a fishing reel apparatus indicated generally at 2. In one embodiment, the apparatus 2 can be mounted on the gunwale of a fishing vessel (not shown). The fishing reel apparatus 2 includes a frame indicated generally at 4. The frame includes two spaced vertical members 6 and 8 joined at a top end by an upper crosspiece 10 and at a lower end by a lower down-turned u-shaped crosspiece 12. Two spaced generally parallel feet 14 and 16 are joined to the free ends 18 and 20 of the lower crosspiece 12. It will be understood by those skilled in the art that the frame 4 can take other suitable configurations. For example, in other embodiments, the lower crosspiece 12 and/or the parallel feet 14 and 16 may be omitted and the vertical members 6 and 8 attached directly to a gunwale.

An upper spool 22 is mounted for rotation on an axle 24 supported at one end by a bracket 26 on the vertical member 8 and at the other end by a bracket 27 on the vertical member 6. The upper spool 22 is for storing, unwinding and winding up a fishing line 28. A fixed bead 30 is attached to the fishing line 28 ahead of a series of hooks 32 attached at intervals on the fishing line 28. The upper spool 22 is also for winding up and unwinding a sheet 34.

A lower spool 36 is mounted for rotation on axle 38 supported at one end by a bracket 40 on the vertical member 8 and at the end by a bracket 41 on the vertical member 6. The lower spool 36 is for storing the sheet 34.

A guide roller 42 is mounted for rotation on a bracket 44 on the vertical member 8. The guide roller 42 is generally parallel to the longitudinal axis of the spools 22 and 36. A wheel 46 is mounted for rotation on the bracket 44. A guide bar 48 generally parallel to the guide roller 42 is attached to a wheel 46 such that the guide bar 48 can rotate along its longitudinal axis with the rotation of the wheel 46. The guide roller 42 and the guide bar 48 help guide the sheet 34 as the sheet is wound and unwound from the lower spool 36.

A lever 50 is attached to the wheel 46 is connected through a linkage 52 to a hydraulic shut off valve 54 on a bracket 56.

A drive pulley 56 is mounted for rotation on a bracket 58 on the vertical member 6. The drive pulley is operably connected through a drive shaft 60 to a hydraulic drive motor (not shown) which drives the drive shaft 60.

A driven pulley 62 is mounted on an axle 64 mounted on brackets 26 and 27. A belt 66 connects the drive pulley 56 and the driven pulley 62 such that when the drive pulley 56 is driven, the belt 66 turns and transfers rotational movement to the driven pulley 62 to turn the upper spool 22.

A central bearing 68 with a torsion spring 70 at one end is supported by and sits in a notched bracket 72 attached to the vertical member 8 and at another end to a bracket 74 attached to vertical member 6. A pulley wheel 76 is on the bearing 68 at the end with the bracket 74. A cord 78 is wound on the pulley wheel 76 and runs to and is wound on a pulley wheel 80 on the axle 38 is rotatably mounted on the central bearing at one end. The torsion spring 70 loads the central bearing 68 and acts through the cord 78 to add resistance to retard the rotation of the lower spool 36.

A hydraulic motor 82 drives the lower spool 36. The hydraulic motor 82 acts through drive shaft 84 meshed with bevel gear 86 which in turn turns bevel gear 88 on axle 38. For simplicity, the hydraulic line to the hydraulic motor 82 is not shown.

A depth gauge gear assembly indicated generally at 90 is mounted on a bracket 92 attached to the vertical member 8. The depth gauge gear assembly 90 includes a bevel gear 94 on shaft 64. The bevel gear 94 is meshed with bevel gear 96. Bevel gear 96 is connected to shaft 98 and worm gear 100 on the shaft 98. Worm gear 100 is meshed with gear set 102 has a gear ratio of about 120:1. The gear set 102 is operably connected to a depth gauge indicated generally at 104. The rotation of the upper spool 22 can be stepped down to the depth gauge by the gearing ratio.

In one embodiment, the sheet 34 is made of plastic. In one embodiment, a first block 3 is provided on a first end of the sheet and a second block 112 is provided on a second end of the sheet 34. A hole 110 is provided in the upper block for receiving the fishing line 28. The diameter of the hole 110 is large enough for the fishing line 28 to pass through but too small for the fixed bead 30 to pass through the hole.

In operation, to wind the line 28 that has been payed out, the rotation of the upper spool 22 is activated which starts the winding of the line 28. As the line 28 is wound, the line 28 passes through the hole 110 until the fixed bead 28 engages the hole 110 at which point, the sheet 34 begins to be unwound from the lower spool 36. As the line 28 continues to be wound on the upper spool 22, the sheet 34 is wound with the line 28 on the upper spool 22, thereby forming a layer barrier between the winds of the line 28. The barrier separates one wind of the hooks 32 from another so that the hooks 32 do not become tangled in one another. The line 28 and the sheet 34 can be wound on the spool until the last hook 32 has been wound.

In operation, to pay out line 28, the rotation of the upper spool 22 is activated and the line 28 is pulled off of the upper spool 22. The rotation of the lower spool 36 is activated to wind up the sheet 34 as the line 28 is payed out. The rotation of the upper and lower spool is stopped when the depth gauge 90 reaches the set payout depth for the line 28 and the drive motors for the upper spool 22 and the lower spool 36 are stopped.

I claim:

1. A fishing reel apparatus comprising:
a frame,
an upper spool on the frame for winding up and paying out a line,
a bead on the line,
a series of hooks at intervals on the line down-line of the bead,
a sheet,
a lower spool on the frame for winding up and paying out the sheet,
an opening in the sheet for receiving the line where the opening is sized to allow the line to pass through without allowing the bead to pass through,
a drive motor operably connected to the upper spool for rotating the upper spool and,
a drive motor operably connected to the lower spool for rotating the lower spool.

2. The fishing reel apparatus further comprising a guide roller on the frame between the upper and lower spools for guiding the sheet when the sheet is payed out.
